(19) United States
(12) Patent Application Publication
(10) Pub. No.: US 2008/0110844 A1
(43) Pub. Date: May 15, 2008

(54) STOCK ROLL DIRECT LOAD SYSTEM

(75) Inventors: James H. LEWIS, Woodbury, MN (US); Brian T. Loesch, Hastings, MN (US); Kevin A. Kysylyczyn, Roseville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/872,734

(22) Filed: Oct. 16, 2007

Related U.S. Application Data
(60) Provisional application No. 60/862,646, filed on Oct. 24, 2006.

(51) Int. Cl. B66C 13/40; B66C 13/04

(52) U.S. Cl. 212/285; 212/270

(57) ABSTRACT

A system and associated methods and software for loading a stock roll onto a center-driven winder/unwind device, or other devices, is described. The system may comprise a bridge crane coupled to two J-hooks operative to hold a stock roll; a chucking system, which engages a stock roll while the stock roll is held by the J-hooks, the chucking system being part of a center-driven winder/unwind device; and, an operating program, running on a computer, providing signals that direct the bridge crane to move the stock roll to a position within the manufacturing environment.

### CROSS REFERENCE TO RELATED APPLICATION

This application claims the benefit of U.S. Provisional Patent Application No. 60/862646, filed Oct. 24, 2006, the disclosure of which is incorporated by reference herein in its entirety.

### BACKGROUND

Manufacturers may use or handle rolled goods in the course of manufacturing activities. These rolled goods may be large (4000 pounds or more) rolls of paper, non-wovens, or other materials, and are termed “stock rolls.” Maneuvering and loading stock rolls into a roll-center driven web handling system is accomplished in many manufacturing facilities with a first apparatus that moves the stock roll into the proper general area of the manufacturing plant and a second apparatus that receives the stock roll from the first apparatus and holds it in place while the web handling system engages the stock roll via a chucking system.

The first apparatus may take the form of carts or forklifts, but often is a bridge crane positioned over the manufacturing area, able to lift and move goods around the manufacturing area. Once the first apparatus has positioned the stock roll in the correct area of the manufacturing environment, the second apparatus more precisely positions the stock roll so an automated chucking system may engage the stock roll and thus load it into the web handling system. The second apparatus, which holds the stock roll so the web handling system may engage it is termed a carriage system.

Once the stock roll is positioned by the carriage system, a chucking system engages the stock roll, sometimes through adapters attached to a hollow core running longitudinally through the middle of the stock roll, and around which the stock roll material is wound. The chucking system may have little or no ability to adjust the trajectories of its chucks, which close in toward one another, to engage the adaptors. Thus the carriage system more precisely positions the stock roll so the chucking system can take the positioning as a given and engage/load the stock roll into the web handling system.

Carriage devices are bulky items that take up space in a manufacturing environment. Carriage devices are often bolted to the floor or other equipment, which makes altering them a time consuming task, and further contributes to a rigid and inflexible manufacturing environment.

### SUMMARY

A stock roll direct load system, and related methods, are described which in some embodiments may position a stock roll for direct loading into a web handling device, possibly obviating the need for a carriage device in some applications. A direct load operating program is described which integrates control of the stock roll direct load system in a computer. The stock roll handling and positioning system, in one embodiment, includes a bridge crane, a chuck engagement confirmation system, a J-hook roll engagement confirmation system, and possibly other sensors as will be described or mentioned to in this specification, all interconnected and/or controlled by a direct load operating program running on a computer.

In one embodiment, the invention is directed to a system for loading a stock roll onto a center-driven winder/unwind device comprising a bridge crane coupled to a stock roll holding mechanism operative to hold a stock roll; a chucking system, which engages a stock roll while the stock roll is held by the stock roll holding mechanism, the chucking system being part of a center-driven winder/unwind device; and, an operating program, running on a computer, providing signals that direct the bridge crane to move the stock roll to a position within the manufacturing environment. In another embodiment, the invention is directed to a method of loading a stock roll directly onto a stock roll winder/unwinder device comprising: positioning a stock roll into a loading position of a web handling device's center-driven winder/unwinder device, wherein the positioning is accomplished using a bridge crane; extending at least one chuck from the winder/unwinder device laterally to engage the stock roll while the stock roll is still held by the bridge crane; and, disengaging the bridge crane from the stock roll.

In another embodiment, the invention is directed to a method comprising positioning a bridge crane with two J-hooks under a stock roll's core, the stock roll being held by a chucking system of a center-driven winder/unwind machine; elevating the J-hooks to seat the stock roll's core within the J-hooks; and, disengaging the chucking system.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a high-level view of an exemplary embodiment of a stock roll direct load system.

FIG. 2 is a diagram of various functional modules comprising an embodiment of a direct load operating program.

FIG. 3 is a schematic of an exemplary bridge crane.

FIG. 4 is a schematic of an exemplary chuck assembly.

FIG. 5 is a schematic of an exemplary J-hook.

FIG. 6 is a flowchart showing high-level steps in processing an incoming stock roll.

FIG. 7 is a flowchart showing high-level steps in processing an incoming core.

FIG. 8 is a flowchart showing high-level steps in loading a stock roll into a center-driven winder/unwind device.

FIG. 9 is a flowchart showing high-level steps in unloading a stock roll from a center-driven winder/unwind device.

### DETAILED DESCRIPTION

As used herein, these terms shall have the following definitions:
“chucks” refer to the members which engage the stock core.
“chucking” is the process whereby the a chuck or two chucks are engage a roll core, sometimes via lateral extension.
“chucking apparatus” is a device with chucks that extend longitudinally to engage roll core.
“dolly” is a device extending from the bridge crane, including means for securing a stock roll, such as J-hooks or air clasps or any other securing means.
“roll core” is an elongated member, often hollow, around which rolled material is wound.
“rolled material” is material wound on a roll core. For example, non-woven sheets such as paper wound on a roll core.
“spindle” means an apparatus that securely holds a removable stock roll, usually comprised of two chucks.
“stock roll” refers to the roll core and its rolled material.

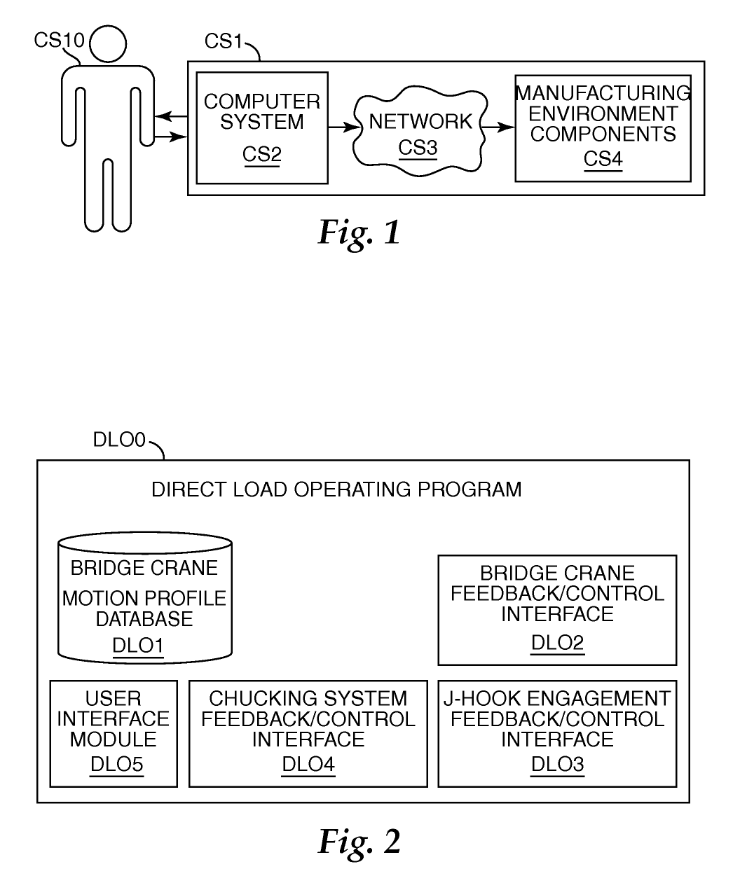

FIG. 1 shows an exemplary stock roll direct load system CS1, which includes computer system CS2, running a program or programs that provide instructions via network CS3 to manufacturing environment components CS4. Computer system CS2 may be any computer system having a memory and processor, and may optionally run an operating system. Computer system CS2 may receive instructions from user CS10 via a user interface or command line, and/or the instructions may be stored on and retrieved, or read, from a computer-readable medium such as a hard drive, memory, CD-ROM, or so forth. Computer system CS2 runs software that, for the purposes of this disclosure, is termed the “direct load operating program”. The direct load operating program will be discussed further with respect to FIG. 2. Network CS3 may be any type of network, including for example a public internet, a private intranet, wired, or wireless. Manufacturing environment components CS4 are components in a manufacturing environment that receive instructions from, and provide feedback to, computer system CS2 via network CS3. In one embodiment further described herein, manufacturing environment components include a bridge crane, a chucking assembly with engagement confirmation, and a J-hook with engagement confirmation. Other manufacturing environment components having the ability to provide information about various aspects of the manufacturing environment are also discussed. Any of these components may include or be physically manipulated by one or more motors, having received instruction from a programmable logic controller (PLC). Any of these components may be capable of providing feedback to computer system CS2, as will be further described herein. In one embodiment all three manufacturing environment components include a PLC, which receives instructions from computer system CS2, possibly via another PLC, and controls devices within the manufacturing environment. Feedback may be received via the PLCs and provided back to computer system CS2, also possibly via another PLC. Feedback received may include information describing the state of one of the manufacturing environment components, or a subcomponent thereof. For the purposes of this dislosure, an architecture is described that includes a computer system CS2 in communication with an offboard PLC, which in turn is in communication with a plurality of onboard PLCs, which control functions of individual manufacturing components. This choice of architecture is but one of many ways to practice the embodiments disclosed herein. One skilled in the art will recognize other architectures that accommodate the this and other embodiments.

User CS10 may be any person, entity, or computer system having an interest in providing input to a computer system that directs a stock roll direct load system CS1. In one embodiment, user CS10 is person working for a manufacturing company, in a manufacturing environment.

Stock roll direct load system CS1 may allow for direct (without the use of a carriage system or similar positioning device) loading and/or unloading of stock rolls, of particular use in a manufacturing environment. Stock roll direct load system CS1 may allow a manufacturer to automatically (without human intervention) transfer rolls from stands and racks directly into center-driven unwind and winder spindle chucks. The stock rolls discussed herein may be up to 4000 pounds for example, containing rolled goods used in a manufacturing environment. Though the context for this disclosure is a manufacturing environment, the same principles may be applied and associated controls scaled up or down to accommodate other applications and stock roll sizes. For unloading, stock roll direct load system CS2 may provide automatic remaining stock roll, or stock roll core if no longer including any wound material, transfers directly from the unwind and winder spindle chucks to stands, racks, and pallets. Stock roll direct load system CS1 may be adaptable to various stock roll loading and unloading scenarios. In some embodiments, including one further described herein, stock roll direct load system does not require additional floor space as other systems might. The stock roll direct load system may, in some embodiments, be useful in the context of manufacturing lines where expedited stock roll changes are desired. The stock roll direct load system, in some embodiments, may be well-adaptable to changes in the layout of a manufacturing environment, especially when compared with systems that do not include various features or benefits of the stock roll direct load system.

### Bridge Crane

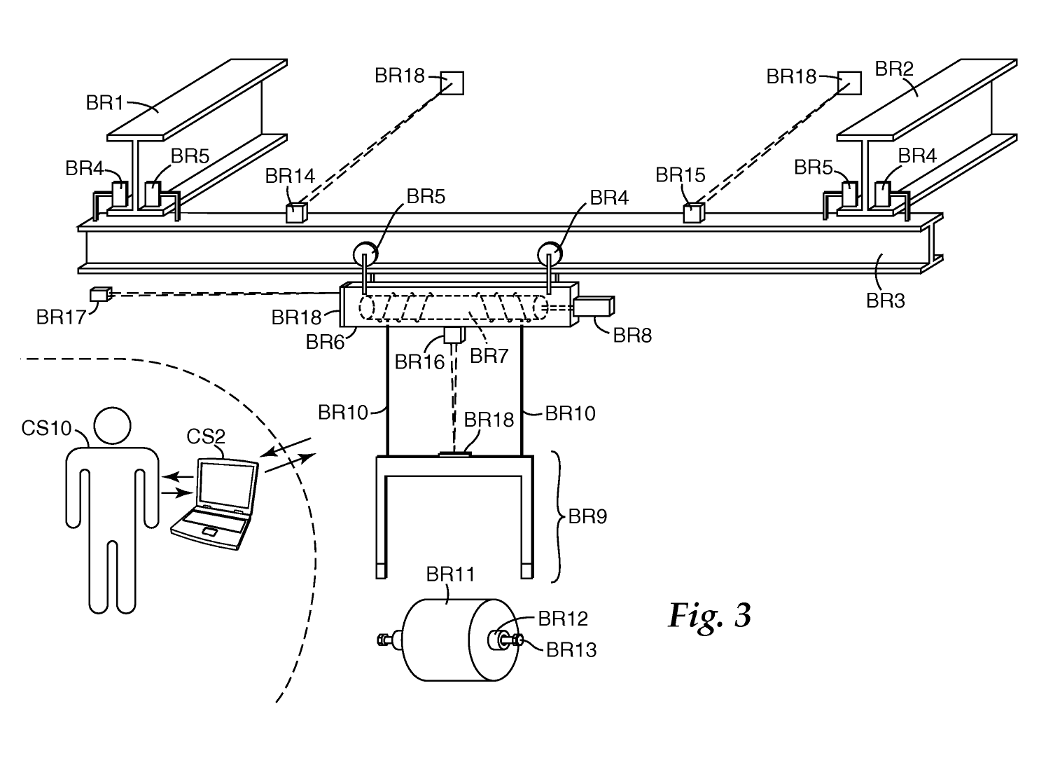

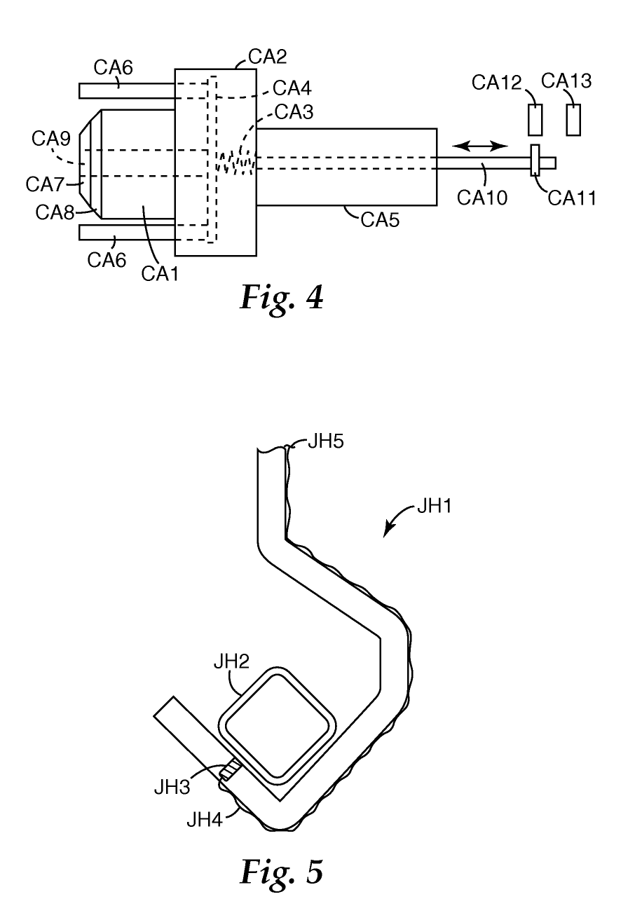

FIG. 3 shows some of the manufacturing environment components CS4 of an exemplary stock roll direct load system. Particularly, an exemplary three axis bridge crane suspending two J-hooks and attached with a cross tube is shown. This bridge crane may be referred to as a precision bridge crane. The precision bridge crane, the chuck assembly shown in FIG. 4, and the J-hook assembly shown in FIG. 5 together comprise one embodiment of manufacturing environment components CS4. One skilled in the art will recognize that some of these components may not be necessary, may be modified, or that other components may be added to enhance various aspects of the stock roll direct load system. Presented herein is merely one embodiment of a stock roll direct load system.

The bridge crane may be any 3-axis bridge crane. In a manufacturing environment, the bridge crane can be maneuvered, typically by a PLC device, to position a payload (in the examples used herein, the payload is a stock roll dolly with two J-hooks) at positions within the range of the bridge crane. In the example presented in FIG. 4, two I-beams, BR1 and BR2, are suspended above a manufacturing environment. A third I-beam, positioned below and substantially perpendicular to the first two I-beams, and suspended from each I-beam by a hanging apparatus which includes set of wheels BR4 and BR5. One of the wheels, driven wheel BR5, is attached to the third I-beam and driven by a motor. The other wheel, non-driven wheel BR4, is also attached to the perpendicular third I-beam to capture I-beam BR1 or BR2, but is not driven by a motor (though in some embodiments it may be). One skilled in the art will recognize embodiments wherein there is no second non-driven wheel. The third I-beam is bridge BR3. Suspended under bridge BR3 is trolley BR6, which is similarly attached to the I-beam that is bridge BR3 by means of a hanging apparatus including a motor-driven wheel BR5 and a non-driven wheel BR5. For the purposes of this specification, movement of trolley BR6 along bridge BR3 is deemed to be along the Y-axis, whereas the movement of bridge BR3 along I-beams BR1 and BR2 is deemed movement in along the X-axis. By controlling the driven wheels BR5, trolley BR6 may be positioned at many positions within the two dimensional space defined by the dimensions of I-beams BR1 and BR2, and bridge BR3.

Trolley BR6 includes drum BR7 and hoist motor BR8. Hoist motor BR8 drives drum BR7, to wind or unwind a stock roll dolly BR9. Stock roll dolly BR9 includes two J-hooks attached by a cross tube. Controlling hoist motor BR8 allows the stock roll direct load system to position stock roll dolly BR9 at many points within the three dimensional space defined by the dimensions of I-beams BR1 and BR2, bridge BR3, and cable BR10's length.

The stock roll direct load system may raise or lower pick up and move stock rolls with dolly BR9 via its J-hooks, by engaging the stock roll's core BR12. Extending from the stock roll's core BR12 may be core adapters BR13, which are used for loading, unloading, and possibly driving the stock roll during manufacturing processes.

The bridge mounted trolley BR6 travels perpendicular to the web direction, often covering the width of the process operation (again, this is termed the Y-axis).

The stock roll direct load system may position its dolly to within ⅛″ of specified X, Y, and Z coordinates. The axis motors comprise 100:1 speed range, inverter-duty models with encoder feedback. Similar motors are sometimes used on web manufacturing lines. High quality, low backlash gearboxes may be used to transfer torque from the axis motors to the wheels. The particular motors and gears used to position the dolly are an implementation-specific detail; one skilled in the art will recognize a myriad of different combinations of motors that could achieve necessary accuracy.

In addition to the X, Y, and Z coordinates discussed above is a coordinate colloquially termed the “tram.” Tram refers to alignment of the dolly relative to the direction of the web processing direction; the tram most often needing to be perpendicular to the direction of the web processing equipment. However, the tram more generically refers to the alignment of the dolly's J-hooks, or the drum, relative to anything within the manufacturing environment. The tram of the dolly, in one embodiment, may be adjusted in the stock roll direct load system by directing motor-driven wheel BR5 of only one I-beam BR1 to move, and holding the other stationary. Tram effectively introduces a second X axis position into the traditional X, Y, and Z axis, and thus the axis will be referred to as X1, X2, Y, and Z, X1 referring to the position of bridge crane BR3 along a first I-beam BR1, X2 referring to the position of bridge crane BR3 along a second I-beam BR2, Y referring to the position of the trolley BR6 along bridge BR3, and Z referring to the position of dolly BR9.

In the embodiment described with respect to FIG. 3, and as mentioned earlier, one motor is responsible for positioning its respective component in each of the X1, X2, Y, and Z dimensions, and controlled by a drive programmed to do the same (four drives). The four motor drives are controlled by a PLC (or a Remote Input/Output Device) that travels with the bridge. This PLC will be referred to as the onboard PLC. This particular embodiment has one onboard PLC, but other implementations could have more PLCs. The onboard PLC is in this embodiment controlled by PLC, which is termed the offboard PLC, and which also may control the chucking system and receive input or control other manufacturing components. The offboard PLC is controlled by computer system CS2, which is in turn controlled by user CS10. One skilled in the art will recognize there the several PLCs described in this exemplary embodiment may be consolidated to one, or the PLC-type functionality moved into another computing device altogether, such as computer system CS2. The PLC controlling the drives that control the motors which direct movement in the X1, X2, Y, and Z dimensions are programmed to slow down before the final coordinate is reached, thus achieving accurate stop positioning.

Along with position commands, the onboard PLC is, in one embodiment, programmed to have a maximum speed, as well as hook loading routine definitions. A hook loading routine definition is a group of parameters that comprise a particular move instruction. For example, the moves needed for a particular J-hook disengagement routine may be programmed within the onboard PLC. The hook loading routine definition may include position commands, maximum travel speed, and required loading state (Load/No Load/Proceed, as will be discussed later in this specification). The hook loading routine could just as well reside within the offboard PLC, or computer system CS2; one skilled in the art will recognize there are pros and cons to various architectures. As will be described later in more detail, the J-hook assembly, which is part of dolly BR9 and used to lift stock rolls, includes an engagement confirmation system which detects whether a stock roll is seated in the J-hook assembly. The onboard and offboard PLC in one embodiment are programmed to modify operations depending on three state conditions, each of which is set by feedback from the J-hook assembly's engagement confirmation system. The three states the PLCs are programmed to honor are Load, No Load, and Proceed. These three states correspond with feedback from the J-hook assembly commensurate with a first condition wherein a stock roll is seated within the J-hook assembly (Load), a second condition wherein nothing is seated within the J-hook assembly (No Load), and a third condition wherein the state of the J-hook (seated or not seated) does not matter (Proceed). Programmatically defining these state conditions may add safety to the stock roll direct load system, and helps accommodate some of the risks associated with such a system. The three states are in essence conditions which must evaluate to True in order for a command to be carried out, and if the condition does not evaluate (and continue to evaluate, throughout the operation of a command) correctly, all operations of the stock roll direct load system are, in one embodiment, immediately halted. For example, take a command provided to the onboard PLCs to set a finished stock roll into a warehouse rack. This command may be broken into, in this simplified example, three sub-commands. The first sub-command may be to lower the dolly several feet, at a high speed. The required state for this is Load, as the stock roll's core should be seated in the J-hook assembly during this maneuver. When the first sub-command is completed, the second sub-command is to continue to lower a short distance (inch or less) at very slow speed, under a required state of Proceed (the PLC does not care whether the condition is Load or No Load because, with this maneuver, the stock roll should have its weight transferred from the J-hooks to the warehouse rack). Finally, the third sub-command is to continue to lower a few more inches at moderate speed, under a state condition of No Load. The second maneuver is relatively small in distance, but precisely located around the rack load-transfer point, where the J-hook assembly engagement confirmation device sensors should transition from Load to No Load.

A similar approach may be used for unloading a stock roll onto a pallet, for example. Setting a stock roll onto a surface comprised of the wound material has a new set of complexities, however, because the stock roll direct load system must take into account other variables (for example the diameter of the stock roll, or the thickness and stack of pallets), which impact the total distance the stock roll direct load system must lower the stock roll to have the stock roll's weight transferred completely to the pallet. The stock roll direct load system may unload the stock roll onto the pallet using the same state condition requirements mentioned above with respect to unloading a stock roll onto a rack, except that the end of the second sub-command is defined by the point at which the J-hook sensor or sensors change states from Load to No Load, rather than being fixed. This prevents other pieces in the dolly that holds the J-hook assembly from going too low, or possibly impacting other articles in proximity to the lowered stock roll.

Hoist drum BR7 may be machined with two precision diameter grooves, mirrored out from the center of the drum, allowing the cables to predictably position themselves as the drum BR7 winds them. This further supports precise, predictable Z-axis movements of the dolly.

A coordinate feedback system provides information describing the location of the dolly. In the embodiment shown in FIG. 1, four lasers are used, though other numbers of lasers or differing coordinate technology, including dead reckoning, sonic, or ultrasonic, could similarly be employed, as one skilled in the art will recognize. Lasers BR14 and BR15 measure the position of bridge BR3 relative to associated laser targets BR18. Measurements from lasers BR14 and BR15 provide two X1 and X2 coordinate measurements. Two measurements are used in this application for setting tram. Laser BR17 measures the position of the trolley relative to the edge of bridge BR3. Laser BR16 measures the position of dolly BR9 relative to trolley BR6. A fifth laser, not pictured in FIG. 1, may measure bridge BR3 deflection relative to the floor of the manufacturing environment, but may not be needed if deflection of bridge BR3 is insignificant, constant, or predictable (can be determined by calculation).

Stock roll direct load system may be controlled by a program running on a computer such as computer CS2. The program, termed for this specification direct load operating program, may interact with operator CS10 through a series of graphical user interfaces. Computer CS2 may be in communication with one or more offboard PLCs, which in turn may be in communication with onboard PLCs, the whole of which control the manufacturing components.

When computer CS2 has positioned a stock roll, held by dolly BR6, into position to be loaded into a web processing environment, a chuck assembly engages the stock roll. Once engaged, the dolly disengages stock roll BR11's core BR12 by lowering and retracting J-hooks. Chuck assembly engagement and J-hook disengagement may be done programmatically without feedback, but in one embodiment feedback is provided by both the chuck assembly and the J-hooks. This feedback may improve safety as the engagement and disengagement should in some embodiments be coordinated and/or confirmed or motor BR8 could pull bridge BR3 off its ceiling mounts, or a stock roll could be dropped. In one embodiment of the stock roll direct load system, feedback mechanisms are incorporated into the design of both the chuck assembly and the J-hooks, and are in communication with computer system CS2.

The chuck assembly includes a feedback mechanism that indicates whether the chuck is engaged (into a stock roll's core) or free (not engaged in a stock roll's core). A FIG. 4 is a chuck assembly that includes this feedback mechanism. The mechanism which provides engagement feedback is termed a chucking engagement confirmation device. One embodiment is shown with respect to FIG. 4, but one skilled in the art will recognize many further means of determining whether a chuck is engaged, including the use of a camera or precise positioning feedback from the chuck assembly relative to precisely positioned stock roll core.

### Chuck Assembly

FIG. 4 is a schematic of an exemplary chuck assembly including a chucking engagement confirmation device. The chuck assembly and the chucking engagement confirmation device may be together referred to as a chucking engagement system. Chuck insert CA1 engages a stock roll's core, in some embodiments via an adapter attached to the stock roll's core. Chuck insert CA1 includes a steep taper CA7 and a shallow taper CA8, both used for guiding chuck insert CA1 into proper alignment with an adapter attached to the stock roll's core. Chuck insert CA1 attaches to chuck body CA2, which attaches to chuck shaft CA5. Spring pins CA6 couple to base plate CA4, which in turn couple to rod CA10; all may move horizontally independent of the rest of the chuck assembly and move in coordination with engagement of chuck insert CA1 into a core adapter coupled to a stock roll's core. Flag CA11 is connected to rod CA10, and the horizontal position of rod CA10 (and thus spring pins CA6 and base plate CA4), relative to the remainder of the chuck assembly may be measured by unchucked sensor CA12, which is associated with an unchucked condition, and chucked sensor CA13, which is associated with a chucked condition. Chuck insert spring pin CA9 senses male air bars. Air bars are devices inserted through the center of a stock roll's core, and serve as male adapters to a female chuck system. In the embodiment described herein, the chucking system may be either male or female, and the chucking engagement system will detect the engagement status of either system.

Chuck assemblies with a chucking engagement confirmation device described above may sense many states, including when a roll is 100% chucked, 100% unchucked, and 100% open. 100% open refers to the state of the chucks themselves being, in one embodiment, as far apart as physically possible, or reaching some pre-set threshold. 100% unchucked condition may indicate that the chuck is out, but the 100% open condition, as reported from the chucking system rather than, in this embodiment, the sensors, may be a good safety hook, which subsequent movements can be based on. This information is provided to and used by the stock roll direct load system to prevent dropping rolls or snagging a web line stand with a hung-up roll. The chuck engagement confirmation device may detect a slight swing condition and provide data describing the same to the stock roll direct load system, which may be programmed to hold the stock roll steady (it does not attempt do disengage it from the J-hooks) while the chucking assembly attempts to re-chuck the stock roll. The slight swinging condition may arise immediately following a chuck engagement attempt, and may be assumed to exist when the sensors do not report a 100% chucked condition when they are expected to. Many swinging conditions are remedied on a second attempt.

Chuck assembly steep taper CA7 and shallow taper CA8 assist engagement. Steep taper CA7 may assist in engaging stock rolls held by dolly BR9 that are not aligned perfectly by dolly BR9 due to an off-center load. This could occur if the stock roll's center of gravity is not aligned with the dolly. Ideally the center of gravity for a stock roll is through core BR12 of the stock roll, a condition for which stock roll direct load system is calibrated. If the center of gravity is not in fact through the center of the roll, the stock roll's actual position along the X axis will be off slightly. Steep taper CA7 is one way to deal with this positional variability. There are other ways to accommodate for this variation, including sensing it and adjusting bridge BR3 accordingly.

### J-Hook Assembly

FIG. 5 is a schematic of an exemplary J-hook assembly with an engagement confirmation device. The J-hook assembly and the engagement confirmation device may together be referred to as a J-hook engagement confirmation system. J-hook JH1 is shown in FIG. 5. Core adapter JH2 is shown seated in J-hook JH1. Proximity sensor JH3 senses when a core adapter is seated in the J-hook, and provides information indicating the same through sensor cable JH4, which continues, in the embodiment shown in FIG. 5, via extended sensor cable JH5.

A traditional dolly for lifting and/or maneuvering stock rolls may be comprised of two J-hooks, in which case two independent sensors could provide feedback on the engagement status of either J-hook.

The J-hook engagement confirmation system provides, in one embodiment, information on the engagement status of the dolly's two J-hooks to the stock roll direct load system, which coordinates the loading and unloading of stock rolls.

### Direct Load Operating Program

Mentioned earlier, with respect to computer system CS2, in FIG. 1, was a computer program running a direct load operating program. The direct load operating program is any program that directs some or all the movements of, and/or received feedback from manufacturing environment components CS4, to enable the direct loading, unloading, or precision maneuvering of stock rolls. FIG. 2 is a diagram showing an exemplary architecture of one embodiment of direct load operating program. The direct load operating program is described with respect to FIG. 1 as running on computer system CS2, operated by user CS10. One skilled in the art will recognize other accommodative architectures. For example, the direct load operating program may be running on a web server, interacting with user CS10 via web pages accessed by a disparately or locally located client computer, PDA, or other handheld device. Functionality attributed to direct load operating program may optionally be attributed to, and implemented within, and in this embodiment, the offboard PLC, which controls the onboard PLC. In other words, the direct load operating program shown with respect to FIG. 2 includes several functional modules, each of which could be implemented in other computer systems, or offboard or onboard PLCs.

Direct load operating program DLO0 includes, in one embodiment, four functional modules and a database component. Functionality described herein which is not attributed to a particular functional module is attributed to the direct load operating program DLO0 generally. Bridge crane feedback/control interface DLO2 controls and receives feedback from the bridge crane. J-hook engagement feedback/control interface DLO3 controls and receives feedback from the J-hooks which extend from dolly BR9, which are part of the bridge crane. In the embodiment described herein, positioning of the J-hooks is a function of positioning dolly BR9, which is a function of the bridge crane. Thus, the J-hook engagement feedback/control interface, in this embodiment, receives information which is generated by the J-hook engagement confirmation device described with respect to FIG. 5. Other embodiments may have J-hooks positionable independent of dolly BR9, and in such embodiments, J-hook engagement feedback/control interface DLO3 may provide control commands. Chucking system feedback/control interface sends commands, and receives feedback from, the chucking systems that engage a stock roll. Feedback received by this module include that generated by the chucking engagement confirmation device, as was described with respect to FIG. 4.

User interface module DLO5 in one embodiment facilitates providing user CS10 with information concerning the stock roll direct load system, and receiving input from user CS10, including, for example, input that programs the stock roll direct load system in a new way. Some embodiments of direct load operating program DLO0 may include other means of interacting with or programming the system. For example, routines or new procedures could be input to the direct load operating program via the loading of a file, rather than or in combination with user CS10. Bridge crane motion profile database DLO1 contains motion profiles. Motion profile database may be any accessible data repository, such as traditional relational databases, or object databases, or flat files, or computer memory. Motion profiles are data structures that specify a movement or series of movements for the stock roll direct load system, and possibly other pertinent information. A motion profile may include, for example, data which describes a series of movements, the speed for each movement, and the expected loading condition/state (Load, No Load, Proceed; described above) for each movement. Motion profiles may be selected by user CS10 via user interface module DLO5, or may be called by other sub-routines or calling programs. Motion profiles may, in one embodiment, include other motion profiles. When a motion profile is selected and run, or executed, the offboard PLC sends each movement step from the motion profile to the appropriate onboard PLC, usually sequentially. When the onboard PLC confirms reaching location specified by the offboard PLC, the onboard PLC indicates the same to the offboard PLC, and the next coordinate or motion command is sent to the onboard PLC. The direct load operating program may effect diagonal movement of the bridge crane or its dolly BR9 by changing more than one of the X1, X2, Y, or Z axis at the same time. Adding or changing motion profiles to bridge crane motion profile database DLO1 may be done by entering coordinates describing a point within the three dimensional area accessible the bridge crane. Alternatively, a learning mode may exist where the bridge crane is moved into position manually, then coordinates gathered from the various sensors.

Bridge crane feedback/control interface DLO2 may be programmed to operate in any of three modes: manual, semi-automatic, and automatic. In manual mode, the bridge crane feedback/control interface DLO2 lets the bridge crane operate like traditional bridge cranes, yielding control to user-operated handheld pushbutton pendants. In semi-automatic mode, bridge crane feedback/control interface DLO2 completes single motion profiles when initiated by an operator providing instruction via user interface module DLO5. In automatic mode, bridge crane feedback/control interface DLO2 follows a series of motion profiles, usually defining an entire task, such as picking up a stock roll and loading it into a winder/unwinder. In automatic mode, user CS10 may not be necessary, and operators on the manufacturing floor may not need to initiate particular bridge crane operations. Rather, operators need only prepare input stock rolls (move them into position for pickup) and remove output material as required.

Sets of motion profiles, such as those used in automatic mode, which define an entire task, are referred to herein as task recipes. Task recipes may be programmed to prompt user CS10 for input, as for example the location, among a pull-down listing of pre-defined locations, where a stock roll is to be picked up. Task recipes may be stored and retrieved from a database, such as bridge crane motion profile database DLO1. Future recipes may be queued, and input provided for them in advance. Recipes may also be scheduled. While user CS10 may provide input defining a recipe to be run, another computer or system may also provide such input. In one embodiment, another system, which defines product runs, specifies the task recipe. For example, a product run definition may include any combination or subset of: product unwind transfer, liner unwind #1 transfer, liner #1 insertion, liner #1 cut-out, liner unwind #2 transfer, liner #2 insertion, liner #2 cut-out, and product winder transfer. This input, once received, may be parsed by direct load operating program DLO0 and converted/translated into the particular task recipes, and in turn the particular motion profiles required to accommodate the desired product run. Further, task recipes may be programmed to receive, as input, input from an operator or sensor on within the manufacturing environment. For example, a recipe may be programmed to pickup a stock roll at a general area in a manufacturing environment, but the particular position to be specified. The recipe may signal a light, sign, or display indicative to a manufacturing site worker to signal, or pick, the location of the necessary stock roll.

Direct load operating program DLO0 may be run from a computer-readable medium such as a hard drive, computer memory, or a DVD-ROM disk.

### Incoming Roll Handling Example

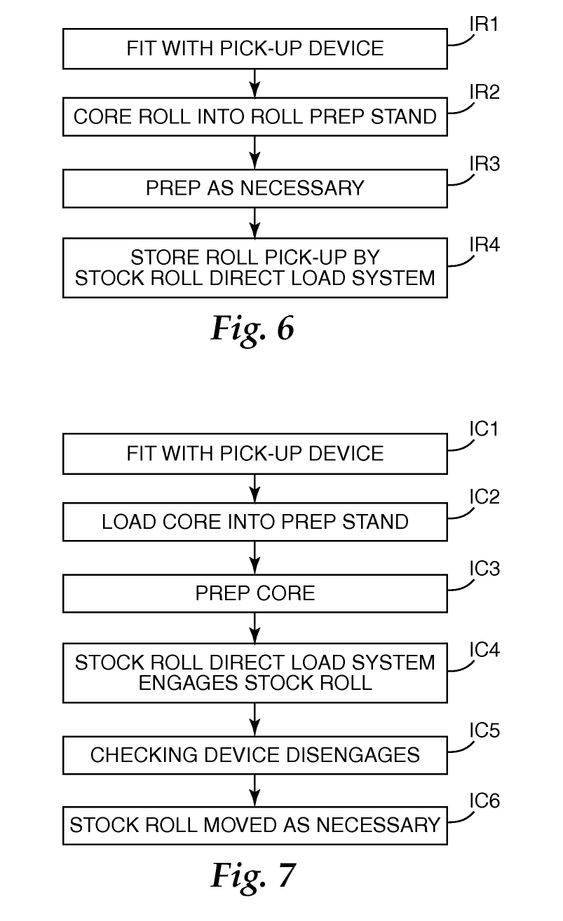

FIG. 6 is a flowchart showing high-level process steps associated with processing an incoming stock roll with stock roll direct load system. This and subsequent flow charts discussed below are for the purposes of illustrating embodiments of use of the stock roll direct load system. One skilled in the art will recognize many further uses or process steps/step combinations that could be used to accomplish many unique tasks.

Incoming stock rolls may initially be fitted as appropriate with a device or devices that facilitate handling of the stock roll in the manufacturing environment (IR1). In some cases this device may be a stock roll adaptor of some sort, or an air bar, discussed above. The stock roll may then be placed into a device sometimes termed a roll prep stand (IR2), so manufacturing plant workers can inspect and prepare the stock roll for its use (IR3). This may mean, for example, removing wrapping that is on the roll, or preparing the first layer for insertion. The specifics of what is done while the stock roll is in the roll prep stand is largely a function of web line particulars. Roll prep stands may include or be serviced by ultrasonic sensors, or other sensors, that detect the presence of stock rolls in the stand. This information may be provided to direct load operating program DLO0, so that stock rolls are not attempted to be placed upon one another. Stock roll direct load system may then direct the bridge crane to lower the dolly, engage with the stock roll with J-hooks, and pick up the stock roll (IR4), the stock roll's position in the roll prep stand having been pre-programmed. Alternatively, if the position has not been pre-programmed, an operator could switch the stock roll direct load system into manual mode, discussed above, and maneuver the J-hooks into engagement position.

FIG. 7 is a flowchart showing high-level process steps associated with processing an incoming core (no material wrapped on core). Empty cores may be used, for example, to wind up, or catch, backer material accompanying other stock roll web materials in a web-handling environment. Incoming cores are fitted with an appropriate device or devices that facilitate handling of the stock roll in the manufacturing environment (IC1). The core is then loaded into a core prep stand similar to the roll prep stand mentioned with respect to FIG. 6 (IC2). The core prep stand may be chuck driven. The core is then prepared (IC3) as necessary. When preparation is complete, an operator may push a button located in proximity to the core prep stand, the button signaling to the stock roll direct load system the readiness of the core. The stock roll direct load system may not immediately retrieve the core, but instead may receive input to mean that the core is ready when the manufacturing process needs it. Eventually the stock roll direct load system engages prepared core (IC4), the chucking system withdraws (if present) (IC5), and the core is lifted and maneuvered into position for loading into the web handling line (IC6).

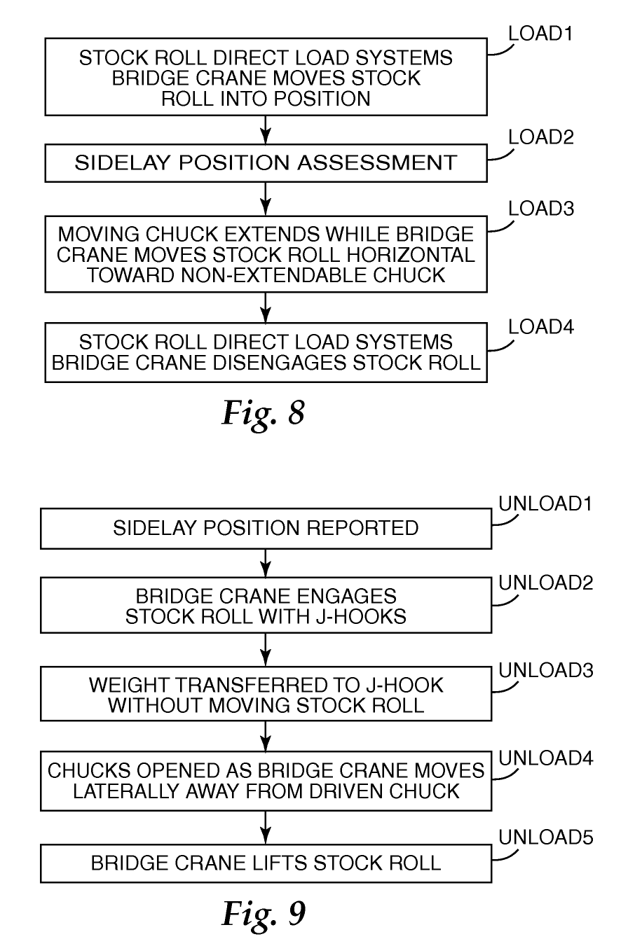

FIG. 8 is a flowchart showing high-level process steps associated with loading a stock roll or core directly into a web handling line's unwind or winder turret chuck (also sometimes called a turret spindle). In one embodiment, the stock roll being loaded may be up to 4000 pounds, and 48″ in diameter, though one skilled in the art will recognize components of the bridge crane direct load system described herein may be scaled up or down to accommodate other sizes and loads as necessary. The turret spindle that will be receiving the stock roll may be rotated or otherwise adjusted, as necessary, to prepare for loading. For example, the driven chuck (as opposed to the non-driven chuck), the turret may be indexed to the proper loading position and the driven chuck rotated for proper square chuck alignment. This pre-load preparation may be done manually or automatically, as part of the stock roll direct load system. The bridge crane component of the stock roll direct load system moves the stock roll into position (LOAD1). Next, the winder/unwinder turret chuck sidelay steering base, upon which the winder/unwinder is in this embodiment located, reports its position to the offboard PLC (LOAD2), and in turn in one embodiment the direct load operating program DLO0. Sidelay steering refers to a device that moves the stock roll in the Y (cross web) direction while winding (if the material is not tracking straight down the web handling machine) or unwinding (the material was not wound perfectly). The sidelay position defines where the chucking system exists so the bridge crane can properly position it in within the Y axis. Once the bridge crane positions the stock roll in consideration of the sidelay position, the stock roll is positioned between the spindle chucks. Typically only the non-driven chuck extends when loading, or chucking, a roll. A chucking engagement routine is retrieved and executed, wherein the moving non-driven chuck extends in coordination with the bridge crane moving the stock roll laterally toward the driven, non-extendable chuck (LOAD3). Confirmation that both or either chucks have engaged the stock roll may be received via chuck roll engagement confirmation device. Finally, the stock roll direct load system disengages its J-hooks (LOAD4).

FIG. 9 is a flowchart showing high-level process steps associated with unloading a stock roll or core directly from a web handling line's unwind or winder turret chuck, or spindle. The steps are similar to those described with respect to the exemplary loading operation, per FIG. 8, but in reverse. After unloading, the bridge crane component of the stock roll direct load system may transport the stock roll to any number of possible locations within the area served by the bridge crane within the manufacturing environment. As with other processes described herein, the onboard PLC is directed via an offboard PLC, and in turn computer system CS2, running stock roll direct load program DLO0. As necessary, the unloading may begin after the turret is indexed to the proper unloading position and/or the driven spindle rotated for proper chuck alignment. First, the sidelay position is reported and translated to the proper Y-axis positioning of dolly BR9's J-hooks (UNLOAD1). The stock roll direct load system then positions the bridge crane, and the J-hooks, appropriately and engages the chucked roll (UNLOAD2). The engagement routine concludes with transferring some of the load to the J-hooks, and from the chucks, without moving the stock roll (UNLOAD3), which aids in removing the chucks. With the weight partially supported by the J-hooks, and thus the bridge crane, the non-driven chuck is withdrawn simultaneous with the bridge crane moving laterally away from the driven chuck (UNLOAD4). Once the chuck engagement confirmation system, described above, sends a signal commensurate with the chucking system no longer being chucked, the bridge crane lifts the stock roll (UNLOAD5).

The unload routine shown with respect to FIG. 9 may be used with respect to partial stock rolls, as would exist when a product run does not use all material on a stock roll. In such a scenario, after the stock roll has been unloaded, it may be returned to any of the roll prep stands for inspection, re-preparation, or storage. Alternatively, the stock roll direct load system may place the stock roll at a pallet location where it may be taken from/returned to the manufacturing area via forklift. In one embodiment, a forklift driver may signal the location for setting a stock roll via pushbutton. When a stock roll is placed in such an area, the area is marked, internal to the stock roll direct load system, as being occupied. The forklift operator may remove the stock roll, then signal via pushbutton or computer, the position as being vacated, and the stock roll direct load system thus removes the occupied flag for that area. Further, a perimeter guard for any forklift area may sense breaches of the forklift area. The perimeter guard may take the form of a light curtain, for example. If the perimeter guard is breached, the bridge crane may be programmed to stop operation until a reset button is pressed, or the perimeter guard indicates no further breach of the perimeter. These are examples of further manufacturing components that may be incorporated into the stock roll direct load system.

Some unload operations may be followed by stock roll direct load system maneuvers based on information fed to the offboard PLC by the web handling system itself. For example, if the webline determines it has unwound a stock roll down to its core, the stock roll direct load operating program DLO0 may be programmed to move such a core to a core stripping stand. Such a stand may be similar to a core prep stand, discussed above, less any motors. The core stripping stand may have a different arrangement, as well (for example, it may be vertical, to save floor space). The bridge crane, after unloading the core, may move the core to the lowest open position on the core stripping stand, which may automatically chuck the core once its presence is sensed. When the bridge crane and its associated dolly are no longer present, an operator may access the stand and clean or otherwise dress down the core, as necessary.

Another type of operation which follows the unload routine may be for finished material. Finished material may be placed directly into a warehouse rack, or set on a pallet for forklift transport, similar to the empty core process mentioned above. Floor pegs may be useful for precisely positioning warehouse racks. As with other placements of stock rolls mentioned herein, when the stock roll is positioned in a location, the stock roll direct load operating program marks the position, internally, as occupied, and will not place another stock roll in that position until the marker has been reset (changed to unoccupied). This re-setting of the marker may be accomplished by, for example, a floor operator pushing a button once the position is cleared, or by the stock roll direct load system moving the stock roll.

### Other Considerations

With the stock roll direct load system described herein, other safety measure may be implemented within the manufacturing environment. For example, each unwind/winder loading area may be guarded and locked to prevent access when the bridge crane is operating generally, or operating within the loading area. The locks may be programmed to only allow access when the bridge crane is not present, or has its dolly positioned low enough so as not to present an overhead hazard to a worker. Further, unlocking the lock may stop the bridge crane, if it is present, and re-locking the lock may indicate the bridge crane is to proceed. These and other modifications are possible by, for example, modifying the bridge crane operating program DLO0 to receive input from another PLC within the manufacturing environment.

The stock roll direct load system may include a training mode. In this mode, the stock load direct load operating program DLO0 records movements made via manual command. These movements are saved as motion profiles and recipes in the bridge crane motion profile database DLO1. The motion profile may then be re-run as necessary, automatically or semi-automatically. A honing jig may help in re-calibrating the position of just-moved or altered equipment. With the use of such a jig, the bridge crane may use sensors to recognize points on a machine. This is useful if, for example, lasers or other location sensing equipment has been recently changed and has a different calibration than previously.

These and other embodiments of are contemplated within the scope of the claims.

1. A system for loading a stock roll into a center-driven winder/unwind device comprising:
a bridge crane coupled to a stock roll holding mechanism operative to hold a stock roll;
a chucking system, which engages a stock roll while the stock roll is held by the stock roll holding mechanism, the chucking system being part of a center-driven winder/unwind device; and,
an operating program, running on a computer, providing a first set of signals that direct the bridge crane to move the stock roll to a position within the manufacturing environment and then providing a second set of signals directing the chucking system to engage the stock roll.

2. The system of claim 1, wherein the stock roll holding mechanism comprises two J-hooks.

3. The system of claim 1, wherein the operating program provides both the first set and the second set of signals automatically.

4. The system of claim 3, further comprising:
a chuck engagement feedback system, which signals whether the chucking system has engaged the stock roll.

5. The system of claim 3, wherein automatically comprises the absence of human intervention.

6. The system of claim 3, wherein the operating program further receives information from the chuck engagement feedback system that describes whether the chucking system has engaged the stock roll.

7. The system of claim 3, wherein the area served by the bridge crane is defined by an X, Y, and Z axis, and the bridge crane able to achieve ⅛″ tolerance to a given coordinate for each of these axis.

8. The system of claim 3, further comprising:
a stock roll holding mechanism engagement feedback system, which signals whether a stock roll is held by the stock roll holding mechanism.

9. The system of claim 2, further comprising:
a J-hook engagement confirmation feedback system, which signals whether a stock roll is seated within a J-hook.

10. The system of claim 9, wherein the operating program further receives information from the J-hook engagement feedback system that describes whether stock roll is seated within the J-hook.

11. A method of loading a stock roll directly onto a stock roll winder/unwinder device comprising:
positioning a stock roll into a loading position of a web handling device's center-driven winder/unwinder device, wherein the positioning is accomplished using a bridge crane controlled by a computer;
extending at least one chuck from the winder/unwinder device laterally to engage the stock roll while the stock roll is still held by the bridge crane, the extension being controlled by the computer; and,
disengaging the bridge crane from the stock roll.

12. The method of claim 11, further comprising:
while extending the chuck, moving the stock roll with the bridge crane laterally in the same direction of the extending chuck.

13. The method of claim 11, wherein the bridge crane holds the stock rolls with J-hooks.

14. The method of claim 13, further comprising:
signaling, from a J-hook engagement confirmation device, that the stock roll is no longer seated within the J-hook.

15. The method of claim 14, further comprising:
withdrawing the bridge crane from proximity of the stock roll.

16. The method of claim 11, further comprising:
receiving, from a chuck engagement confirmation system, confirmation that the chuck has engaged the stock roll.

17. The method of claim 16, wherein the chuck engagement confirmation system is comprises at least one pin extending laterally from a chucking device, and whose lateral movement is obstructed during the chucking process, and this lateral movement detected by a sensor.

18. The method of claim 11, wherein the positioning, extending, and disengaging is controlled by a computer system.

19. A computer-implemented method comprising:
providing signals that position a bridge crane with two J-hooks under a stock roll's core, the stock roll being held by a chucking system of a center-driven winder/unwind machine;
providing signals that elevate the J-hooks to seat the stock roll's core within the J-hooks; and,
providing signals that disengage the chucking system.

20. The method of claim 19, further comprising:
receiving feedback from a J-hook engagement confirmation device confirming the stock roll's core is seated within the J-hook.

21. The method of claim 20, further comprising:
receiving feedback from a chucking system engagement confirmation device indicating the stock roll is no longer engaged with the chucking system.

22. The method of claim 21, further comprising:
while disengaging the chucking system, providing signals to the bridge crane that cause it to move the stock roll laterally in the retracting direction of a retracting chuck from the chucking system.

23. The method of claim 22, further comprising:
after elevating the J-hooks to seat the stock roll's core, providing signals to the bridge crane that transfer at least some of the weight of the stock roll to the J-hooks without moving the stock roll.

24. A computer-readable medium having computer-executable instructions for performing a method comprising:
receiving coordinates defining a three dimensional position served by a bridge crane;
providing commands which cause a bridge crane to move a stock roll to the position; and,
providing commands which cause a chucking system of a center-driven winder/unwind device to engage the stock roll, the stock roll still held by the bridge crane at the point of the chucking system's engagement.

25. The computer-readable medium of claim 24, the instructions further comprising:
providing commands which cause the bridge crane to disengage from the stock roll.

26. The computer-readable medium of claim 24, the instructions further comprising:
receiving information from a chucking system engagement confirmation device indicating whether the chucking system is engaged or disengaged from the stock roll.

27. The computer-readable medium of claim 26, wherein the bridge crane holds the stock roll by two J-hooks, the instructions further comprising:
receiving information from a J-hook engagement confirmation device indicating whether the stock roll's core is seated within the J-hooks.

28. The computer-readable medium of claim 27, the instructions further comprising:
providing commands which cause the bridge crane to move the stock roll in the direction of an extending chuck from the chucking system, the bridge crane movement direction to be simultaneous with the engagement of the chucking system.

29. A computer-readable medium having computer-executable instructions for performing a method comprising:
providing commands which cause a bridge crane to move a set of J-hooks to a position where a stock roll's core is seated within the J-hooks, the stock roll being held by a chucking system of a center-driven winder/unwind device; and,
providing commands which cause the chucking system to disengage the stock roll.

30. The computer-readable medium of claim 29, the instructions further comprising:
providing commands which cause the bridge crane to lift the stock roll.

31. The computer-readable medium of claim 29, the instructions further comprising:
receiving information from a chucking system engagement confirmation device indicating whether the chucking system is engaged or disengaged from the stock roll.

32. The computer-readable medium of claim 31, the instructions further comprising:
receiving information from a J-hook engagement confirmation device indicating whether the stock roll's core is seated within the J-hooks.

33. The computer-readable medium of claim 32, the instructions further comprising:
providing commands which cause the bridge crane to move the stock roll in the direction of the chucking system's withdrawing chuck, the bridge crane movement direction to be simultaneous with the disengagement of the chucking system.

34. A computer-readable medium having computer-executable instructions for performing a method comprising:
receiving signals from a chucking engagement confirmation device, the signals being indicative of at least two states of a chucking system: chuck engaged, or chuck not engaged; and,
based on the signals, providing bridge crane operating signals directing a bridge crane to move.

35. The computer-readable medium of claim 34, wherein the movement specified by the bridge crane operating signals effecting the lifting or lowering of a stock roll.

36. The computer-readable medium of claim 34, wherein the chucking engagement confirmation device is a device coupled to the chucking system, measuring whether the chuck is engaged or not engaged.

37. The computer-readable medium of claim 36, wherein measurement of whether the chuck is engaged or not engaged is done via mechanical sensors.

38. The computer-readable medium of claim 36, wherein measurement of whether the chuck is engaged or not engaged is done via non-mechanical sensors.

39. A computer-readable medium having computer-executable instructions for performing a method comprising:
receiving signals from a J-hook engagement confirmation device, the signals being indicative of whether a stock roll's core is seated in a J-hook coupled to a bridge crane; and,
based on the signals received from the J-hook engagement confirmation device, providing signals directing a bridge crane to move.
